(19) United States
(12) Patent Application Publication
(10) Pub. No.: US 2025/0076596 A1
(43) Pub. Date: Mar. 6, 2025

(54) STRUCTURE AND METHOD FOR FASTENING OPTICAL FIBER CABLE TO SILICON PHOTONICS COMMUNICATIONS DEVICE

(71) Applicant: Marvell Asia Pte Ltd, Singapore (SG)

(72) Inventors: Pei-Keng Fu, Zhubei (TW); Yi-Shiun Chen, New Taipei City (TW)

(21) Appl. No.: 18/818,109

(22) Filed: Aug. 28, 2024

Related U.S. Application Data
(60) Provisional application No. 63/536,809, filed on Sep. 6, 2023.

(51) Int. Cl. G02B 6/42

(52) U.S. Cl. CPC G02B 6/423; G02B 6/4239; G02B 6/424; G02B 6/4245; G02B 6/4249; G02B 6/4257; G02B 6/4262; G02B 6/4267

(57) ABSTRACT

A silicon photonics communications device, configured for fastening thereto a fitting of an optical fiber cable, includes an integrated circuit structure having optical transducers thereon and having a first surface, and a fastening block having a bonding area of a block surface bonded to the first surface and having a cantilevered arm having a cantilever surface parallel to the first surface. The cantilever surface is configured for bonding to the fitting at a cantilever area at least as large as the bonding area, and is spaced away from the block surface by a step distance to accommodate alignment of the fitting to the optical transducers. Where the optical transducers are on a second surface perpendicular to the first surface, the arm extends beyond the second surface, and holds an end face of the fitting, at which ends of optical fibers are exposed, adjacent to the optical transducers.

### CROSS REFERENCE TO RELATED APPLICATIONS

This disclosure claims the benefit of copending, commonly-assigned U.S. Provisional Patent Application No. 63/536,809, filed Sep. 6, 2023, which is hereby incorporated by reference herein in its entirety.

### FIELD OF USE

This disclosure relates to bonding of an optical fiber cable to a silicon photonics device. More particularly, this disclosure relates to a structure and method for bonding an optical fiber cable to a silicon photonics device with less susceptibility to detachment caused by bending or transverse forces.

### BACKGROUND

The background description provided herein is for the purpose of generally presenting the context of the disclosure. Work of the inventors hereof, to the extent the work is described in this background section, as well as aspects of the description that may not otherwise qualify as prior art at the time of filing, are neither expressly nor impliedly admitted to be prior art against the subject matter of the present disclosure.

A silicon photonics device typically includes a silicon integrated circuit die including optical transducers (e.g., photodetectors for reception and laser diodes for transmission), which may be in an edge surface of the die. An optical fiber cable, having one or more optical fibers terminating in a fitting flush with the flat end of each fiber, may be mounted with the fiber ends aligned to the optical transducers. In a typical method for bonding the optical fiber cable fitting to the silicon photonics device, after alignment, a rectangular solid block, e.g., made of glass, has one face (typically one of its two largest faces) bonded (e.g., by a suitable epoxy or other adhesive) to one of the major surfaces of the die (which define a major plane of the die) that is orthogonal to the edge surface bearing the optical transducers. Another face of the rectangular solid block (typically one of its two smallest faces), parallel to the edge surface bearing the optical transducers, is bonded to the end face of the optical fiber cable fitting. The bond between the small face of the rectangular solid block and the end face of the optical fiber cable fitting is susceptible to breakage resulting from application of any force that tends to push the optical fiber cable fitting out of the major plane of the die, especially a bending or transverse force along the interface between the optical fiber cable fitting and the edge of the die.

### SUMMARY

In accordance with implementations of the subject matter of this disclosure, a silicon photonics communications device, configured for fastening thereto a fitting of an optical fiber cable, includes an integrated circuit structure having optical transducers thereon and having a first surface, and a fastening block having a bonding area of a block surface bonded to the first surface and having a cantilevered arm having a cantilever surface parallel to the first surface. The cantilever surface is configured for bonding to the fitting of the optical fiber cable at a cantilever area at least as large as the bonding area, and the cantilever surface is spaced away from the block surface by a step distance to accommodate alignment of the fitting of the optical cable to the optical transducers.

In a first implementation of such a silicon photonics communications device, the optical transducers are on a second surface perpendicular to the first surface, and the cantilevered arm extends beyond the second surface, and is configured for bonding to the fitting of the optical fiber cable to hold an end face of the fitting of the optical fiber cable, at which ends of optical fibers are exposed, adjacent to the optical transducers on the second surface.

According to a first aspect of that first implementation, the cantilever surface may be configured for bonding to the fitting of the optical fiber cable at a cantilever area at least 150% as large as the bonding area.

According to a second aspect of that first implementation, the step distance may be selected, taking into account thickness of a bonding layer, so that the exposed ends of the optical fibers are aligned with the optical transducers.

In a second implementation of such a silicon photonics communications device, the block surface may be separated from the cantilever surface by a right-angle step.

In a third implementation of such a silicon photonics communications device, the block surface may be separated from the cantilever surface by a chamfered edge.

In a fourth implementation of such a silicon photonics communications device, the fastening block may have a first coefficient of thermal expansion that is matched to a second coefficient of thermal expansion of the integrated circuit structure.

According to a first aspect of that fourth implementation, the integrated circuit structure is a silicon die, and the fastening block is glass.

In accordance with implementations of the subject matter of this disclosure, a method of fastening a fitting of an optical fiber cable to a silicon photonics communications device, where the silicon photonics communications device includes an integrated circuit structure having optical transducers thereon and having a first surface, includes bonding to the first surface a block surface of a fastening block, the fastening block having a cantilevered arm having a cantilever surface parallel to the block surface, configuring the cantilever surface for bonding to the fitting of the optical fiber cable at a cantilever area at least as large as the bonding area, and spacing the cantilever surface away from the block surface by a step distance to accommodate alignment of the fitting of the optical cable to the optical transducers.

A first implementation of such a method, where the optical transducers are on a second surface perpendicular to the first surface, may include extending the cantilevered arm beyond the second surface, and configuring the cantilevered arm for bonding to the fitting of the optical fiber cable to hold an end face of the fitting of the optical fiber cable, at which ends of optical fibers are exposed, adjacent to the optical transducers on second surface.

According to a first aspect of that first implementation, configuring the cantilever arm for bonding to the fitting of the optical fiber cable to hold an end face of the fitting of the optical fiber cable, at which ends of optical fibers are exposed, adjacent to the optical transducers on second surface, may include configuring the cantilever arm for bonding to the fitting of the optical fiber cable at a cantilever area at least 150% as large as the bonding area.

A second aspect of that first implementation may include selecting the step distance, taking into account thickness of a bonding layer, so that the exposed ends of the optical fibers are aligned with the optical transducers.

A second implementation of such a method may include separating the block surface from the cantilever surface by a right-angle step.

A third implementation of such a method may include separating the block surface from the cantilever surface by a chamfered edge.

A fourth implementation of such method may include matching a first coefficient of thermal expansion of the fastening block to a second coefficient of thermal expansion of the integrated circuit structure.

In accordance with implementations of the subject matter of this disclosure, a photonic communications assembly includes an optical fiber cable having a cable fitting, a silicon photonics integrated circuit communications structure having optical transducers thereon and having a first surface, and a fastening block having a bonding area of a block surface bonded to the first surface and having a cantilevered arm having a cantilever surface parallel to the first surface. The cantilever surface is bonded to the fitting of the optical fiber cable at a cantilever area at least as large as the bonding area, and the cantilever surface is spaced away from the block surface by a step distance to accommodate alignment of the fitting of the optical cable to the optical transducers.

In a first implementation of such a photonic communications assembly, the optical transducers may be on a second surface perpendicular to the first surface, and the cantilevered arm may extend beyond the second surface, and may be configured for bonding to the fitting of the optical fiber cable to hold an end face of the fitting of the optical fiber cable, in which ends of optical fibers are exposed, adjacent to the second surface.

According to a first aspect of that first implementation, the cantilever surface may be configured for bonding to the fitting of the optical fiber cable at a cantilever area at least 150% as large as the bonding area.

According to a second aspect of that first implementation, the step distance may be selected, taking into account thickness of a bonding layer, so that the exposed ends of the optical fibers are aligned with the optical transducers.

In a second implementation of such a photonic communications assembly, the block surface may be separated from the cantilever surface by a right-angle step.

In a third implementation of such a photonic communications assembly, the block surface may be separated from the cantilever surface by a chamfered edge.

In a fourth implementation of such a photonic communications assembly, the fastening block may have a first coefficient of thermal expansion that is matched to a second coefficient of thermal expansion of the integrated circuit structure.

According to a first aspect of that fourth implementation, the integrated circuit structure includes a silicon die, and the fastening block is glass.

### BRIEF DESCRIPTION OF THE DRAWINGS

Further features of the disclosure, its nature and various advantages, will be apparent upon consideration of the following detailed description, taken in conjunction with the accompanying drawings, in which like reference characters refer to like parts throughout, and in which:

FIG. 1 is a plan view of a silicon photonics integrated circuit device with which implementations of the subject matter of this disclosure may be used;

FIG. 2 is a bottom perspective view of the silicon photonics integrated circuit device of FIG. 1;

FIG. 3 is a perspective view of an optical cable assembly with which implementations of the subject matter of this disclosure may be used;

FIG. 4 is a bottom perspective view of a fastening block according to a first implementation of the subject matter of this disclosure;

FIG. 5 is a side view of the fastening block of FIG. 4 fastening an optical cable assembly as in FIG. 3 to a silicon photonics integrated circuit device as in FIGS. 1 and 2;

FIG. 6 is a bottom perspective view of a fastening block according to a second implementation of the subject matter of this disclosure;

FIG. 7 is a side view of the fastening block of FIG. 6 fastening an optical cable assembly similar to that of FIG. 3 to a silicon photonics integrated circuit device as in FIGS. 1 and 2; and

FIG. 8 is a flow diagram illustrating a method in accordance with implementations of the subject matter of this disclosure.

### DETAILED DESCRIPTION

As noted above, a silicon photonics device typically includes a silicon integrated circuit die including optical transducers (e.g., photodetectors for reception and laser diodes for transmission), which may be in an edge surface of the die. An optical fiber cable, having one or more optical fibers terminating in a fitting flush with the flat end of each fiber, may be mounted with the fiber ends aligned to the optical transducers. In a typical method for bonding the optical fiber cable fitting to the silicon photonics device, after alignment, a rectangular solid block, e.g., made of glass, has one face (typically one of its two largest faces) bonded (e.g., by epoxy or other suitable adhesive) to one of the major surfaces of the die (which define a major plane of the die) that is orthogonal to the edge surface bearing the optical transducers. Another face of the rectangular solid block (typically one of its two smallest faces), parallel to the edge surface bearing the optical transducers, is bonded to the end face of the optical fiber cable fitting. The bond between the small face of the rectangular solid block and the end face of the optical fiber cable fitting is susceptible to breakage resulting from application of any force that tends to push the optical fiber cable fitting out of the major plane of the die, especially a bending or transverse force along the interface between the optical fiber cable fitting and the edge of the die, particularly in view of the relatively small area of the bond between the small face of the rectangular solid block and the end face of the optical fiber cable fitting.

In a known alternative to the rectangular solid block, a cantilevered arm may extend from the optical fiber cable fitting, in a direction parallel to the optic fibers, for adhering to a major surface of the silicon photonics integrated circuit die. However, the optical fiber cable fitting has to be capable of moving in all directions relative to the silicon photonics integrated circuit die during active alignment of the optical fiber cable fitting with the optical transducers in the edge face of the silicon photonics integrated circuit die. Therefore, the bonding surface of the cantilevered arm has to be relatively far from the bonding area on the major surface of the silicon photonics integrated circuit die to allow for movement of the optical fiber cable fitting during the active alignment process. Thus, the cantilevered arm plays no alignment role, and a relatively thick adhesive or epoxy layer is required between the cantilevered arm and the bonding area of the major surface of the silicon photonics integrated circuit die.

In accordance with implementations of the subject matter of this disclosure, a stronger bond may be formed between an optical fiber cable fitting and a fastening block that is bonded to a surface of a silicon photonics integrated circuit die. That surface of the silicon photonics die is parallel to a major plane of the silicon photonics die, and is perpendicular to the edge of the silicon photonics die that contains the optical transducers. The fastening block has an overhang, or cantilever, arm extending out beyond the edge of the silicon photonics integrated circuit die. The surface of the cantilever arm that is closer to the plane of the surface of the silicon photonics die, to which the fastening block is bonded, provides a bonding surface, for attachment of the optical fiber cable fitting, that is comparable in area to—i.e., at least about the same as, and in some implementations at least about 150% of the area of—the bond between the fastening block and the surface of the silicon photonics die. Thus, the attachment of the optical fiber cable fitting to the surface of the silicon photonics die is much less likely to fail because of a bending force or other transverse force, as compared to an attachment that relies on the small face of a rectangular solid block.

The material of a fastening block according to the subject matter of this disclosure may be selected to have a coefficient of thermal expansion similar to the silicon photonics integrated circuit die. That way, the fastening block and the die will expand and contract similarly as temperatures fluctuate, so that the bond between the fastening block and the die is not weakened by expansion and contraction. For example, the fastening block may be made of a glass material, which is mostly silicon, so that it has a coefficient of thermal expansion similar to the silicon photonics die, which also is mostly silicon.

A fastening block of the type just described may have an “L” shape, with the cantilever arm being the upright of the “L” shape, having a bonding surface for fastening the optical cable end fitting. The portion of the “L-shaped” fastening block that is used for fastening to the silicon photonics integrated circuit die serves as the “base” or “foot” of the “L” shape, and has a bonding surface for fastening to the silicon photonics integrated circuit die. Because the L-shaped fastening block does not have to be placed until after the active alignment of the optical cable end fitting to the optical transducers has been completed, meaning that the L-shaped fastening block will not interfere with active alignment of the optical cable end fitting to the optical transducers, the distance between the bonding surface of the base or foot of the “L” shape to the bonding surface of the upright of the “L” shape can be approximately the same as the height of the optical cable end fitting above the bonding surface of the silicon photonics integrated circuit die, allowing for better adhesion of the L-shaped fastening block to both the optical cable end fitting and the surface of the silicon photonics integrated circuit die. In some implementations, the thickness of each of the adhesive layers for each of those bonds may be about 60 μm or less.

In some implementations, the edge of the base or foot of the L-shaped fastening block adjacent the upright, or cantilever arm, of the L-shaped fastening block is chamfered, so that there is a ramp, rather than a right-angle step, between the bonding surface of the cantilever arm and the bonding surface of the base or foot. For example, the chamfer angle may be between 20° and 70°. The optical cable end fitting may be chamfered, above the cable end face, to match the chamfered surface of the L-shaped fastening block.

The provision of the chamfered surface or ramp reduces stress where the cantilever arm meets the base or foot, further strengthening the bond between the optical cable end fitting and the silicon photonics die against bending or transverse forces. Moreover, because the adhesive strength of the adhesive or epoxy bond layer is weakest in a direction perpendicular to the plane of the bond layer and strongest in a shearing direction parallel to the plane of the bond layer, provision of the chamfered surface of fastening block allows an adhesive or bond layer between that chamfered surface and a corresponding chamfered surface of the optical cable end fitting to contribute to increasing the strength of the bond between the optical cable end fitting and the silicon photonics die against bending or transverse forces, as compared to a right-angle step, where the bending or transverse force would tend to try to separate the bond layer in a direction perpendicular to the bond layer.

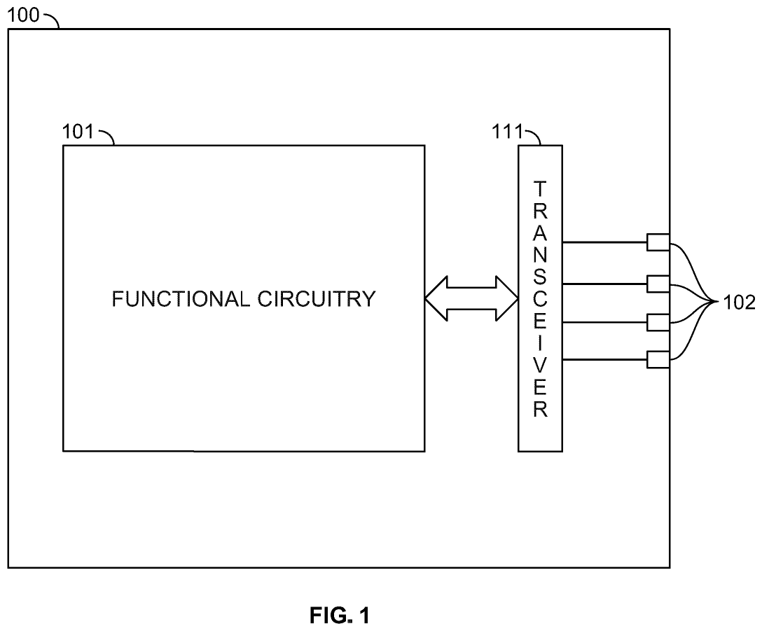

The subject matter of this disclosure may be better understood by reference to FIGS. 1-8.

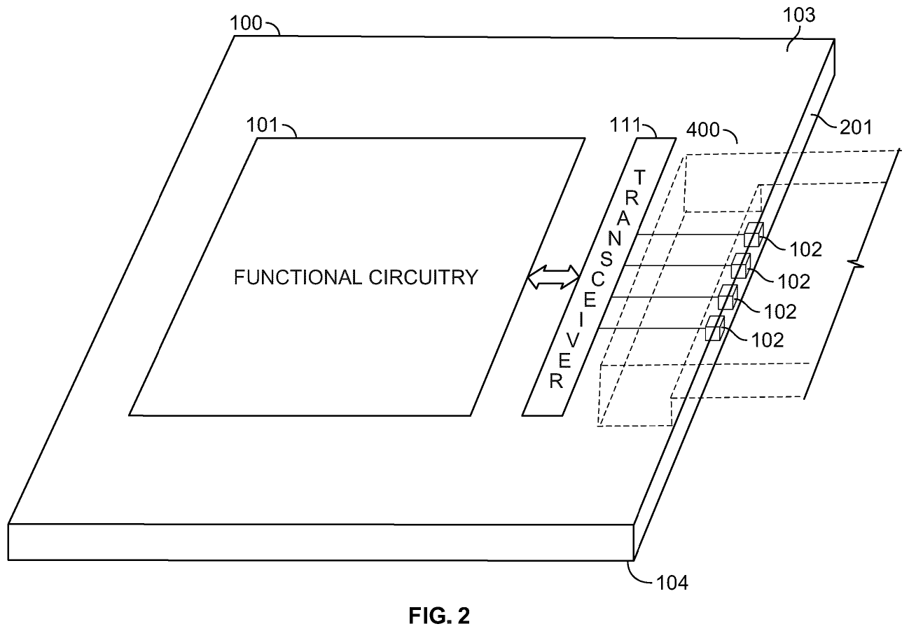

A silicon photonics integrated circuit die 100 with which the subject matter of this disclosure may be used is shown in FIGS. 1 and 2. Silicon photonics integrated circuit die 100 includes a collection of functional circuitry 101, along with transceiver circuitry 111 coupled to electro-optical transducers 102 (which may include laser diodes or other light-emitting elements for transmission, as well as photodiodes or other light-detecting elements for reception). As best seen in FIG. 2, electro-optical transducers 102 in this implementation are mounted in an edge face 201 of silicon photonics integrated circuit die 100, for edge connection to an optical fiber cable assembly 300 (including optical cable fibers 301 and optical cable end fitting 302) as discussed below. However, in other implementations (not shown), the connection to optical fiber cable 300 may be made on one of the upper or lower major surfaces 103, 104 of silicon photonics integrated circuit die 100. A fastening block 400 may be used to fasten optical cable end fitting 302 with its optical cable fibers in alignment with electro-optical transducers 102, as discussed in more detail below.

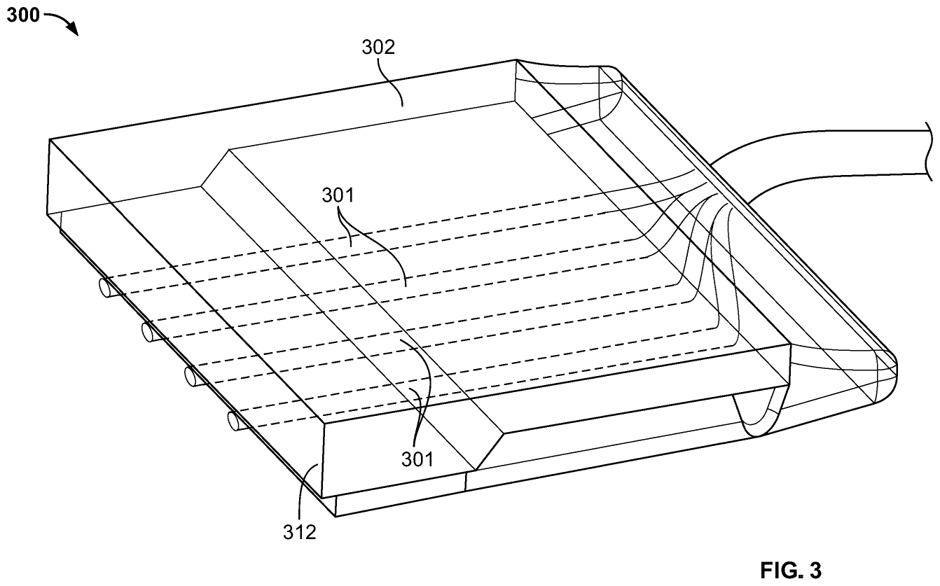

As seen in FIG. 3, optical fiber cable 300 includes a plurality of (e.g., in the implementation shown, four) optical fibers 301, which terminate adjacent the face 312 of optical cable end fitting 302. Optical cable end fitting 302 maintains the individual optical fibers 301 spaced apart to match the spacing of electro-optical transducers 102.

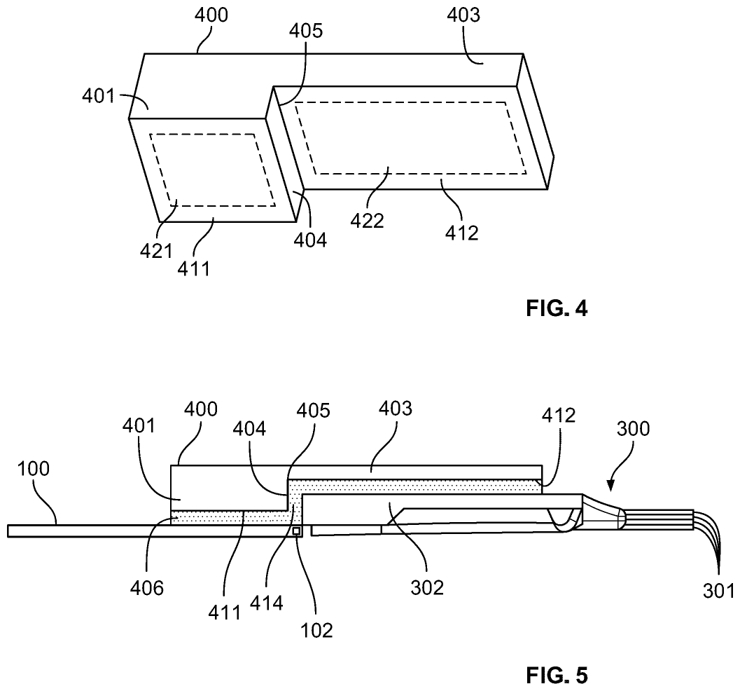

A first implementation 400 of an L-shaped fastening block in accordance with the subject matter of this disclosure, for fastening optical cable end fitting 302 to silicon photonics integrated circuit die 100, so that the ends of optical fibers 301 adjacent face 312 of optical cable end fitting 302 are aligned with electro-optical transducers 102, is shown in FIGS. 4 and 5. L-shaped fastening block 400 has a first fastening surface 411 on base or foot 401 that serves as a bonding area 421 for bonding L-shaped fastening block 400 to the “upper” (based on the orientation of FIG. 4) major surface 103 of silicon photonics integrated circuit die 100. Cantilevered arm 403 of L-shaped fastening block 400 has a second fastening surface 412 that encompasses a bonding area 422 for bonding L-shaped fastening block 400 to optical cable end fitting 302.

The height of step 404 is selected so that when optical cable end fitting 302 is fastened to bonding area 422 of L-shaped fastening block 400, and accounting for a thickness of adhesive or epoxy 406 of no more than, in this implementation, 60 μm at each of bonding areas 421, 422, the ends of optical fibers 301 adjacent face 312 of optical cable end fitting 302 are aligned, in the direction perpendicular to the major plane of silicon photonics integrated circuit die 100, with electro-optical transducers 102.

In order to provide the desired resistance to bond failure in the case of a bending or transverse force, bonding area 422 of the surface 412 on the cantilever arm 403 of L-shaped fastening block 400 should be at least the same as, and in some implementations 150% of, the bonding area 421 of the surface 411 of base or foot 401. The adhesive or epoxy 406 may be present at 414 along step 404, but because an adhesive bond is less strong against shear in the plane of the bond, any adhesive or epoxy present at 414 along step 404 would not contribute significantly to resistance to bond failure from a transverse or bending force.

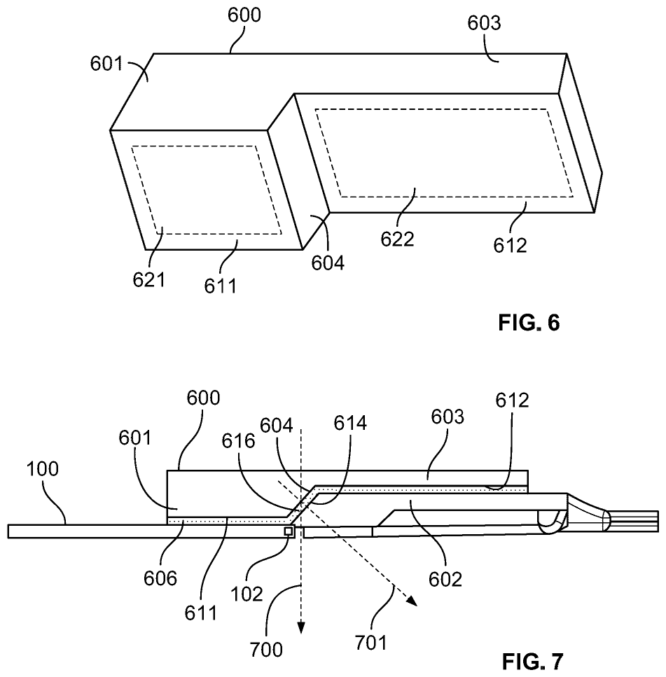

It may be observed that during application of a bending or transverse force, there is a relatively large amount of stress at the corner 405 where cantilever arm 403 meets step 404. Therefore, in accordance with other implementations of the subject matter of this disclosure, instead of step 404, the transition between the bonding surface of the base or foot of L-shaped fastening block 600 (see FIGS. 6 and 7) may be chamfered, so that there is a ramp 604, rather than a right-angle step 404, between the bonding area 622 of the surface 612 of the cantilever arm 603, and the bonding area 621 on the surface 611 of the base or foot 601.

In addition to relieving stress, provision of the chamfer or ramp 604 may improve the bonding of the optical cable end fitting 602 (similar to optical cable end fitting 302 but having a chamfered surface 614) and the silicon photonics integrated circuit die 100 against bending or transverse forces. Because the adhesive strength of an adhesive or epoxy bond layer is weakest in a direction perpendicular to the plane of the bond layer and strongest in a shearing direction parallel to the plane of the bond layer, provision of the chamfered surface or ramp 604 of L-shaped fastening block 600 allows the portion 616 of an adhesive or bond layer 606 between that chamfered surface 604 and a corresponding chamfered surface 614 of the optical cable end fitting 602 to contribute to increasing the strength of the attachment of the optical cable end fitting 602 to the silicon photonics integrated circuit die 100 against bending or transverse forces (as compared to a right-angle step 404, where the bending or transverse force would tend to try to separate the bond layer 414 in a direction perpendicular to bond layer 414), because a component 701 of the transverse force 700 will be parallel to the chamfer or ramp 604 where the bond is strongest.

As noted above, the material of L-shaped fastening block 400 or L-shaped fastening block 600 according to the subject matter of this disclosure may be selected to have a coefficient of thermal expansion similar to silicon photonics integrated circuit die 100. That way, L-shaped fastening block 400, 600 and silicon photonics integrated circuit die 100 will expand and contract similarly as temperatures fluctuate, so that the bond between L-shaped fastening block 400, 600 and silicon photonics integrated circuit die 100 is not weakened by expansion and contraction. For example, the L-shaped fastening block 400, 600 may be made of a glass material, which is mostly silicon, so that it has a coefficient of thermal expansion similar to silicon photonics integrated circuit die 100, which also is mostly silicon.

In accordance with implementations of the subject matter of this disclosure, an optical fiber cable 300 may be aligned with, and bonded to, a silicon photonics integrated circuit die 100 by aligning face 312 of optical cable end fitting 302 with edge face 201 of silicon photonics integrated circuit die 100. Optical cable end fitting 302 may be moved transversely to the major plane of silicon photonics integrated circuit die 100 while optical signals are applied to electro-optical transducers 102. The transverse movement of the optical cable end fitting 302 is stopped when the signal detected at the other end (not shown) of the optical fiber cable 300 is strongest.

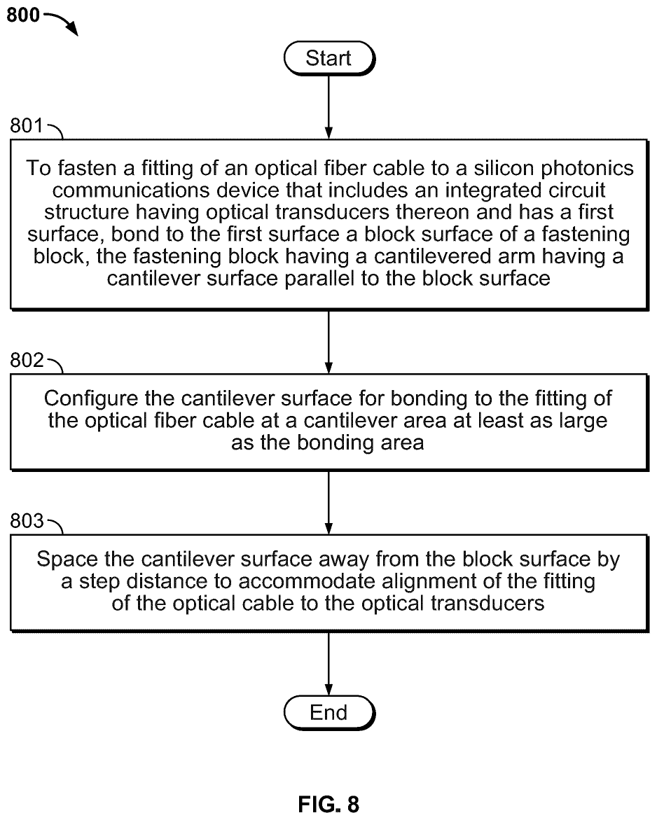

A method 800 according to implementations of the subject matter of this disclosure is diagrammed in FIG. 8. Method 800 begins at 801, where, to fasten a fitting of an optical fiber cable to a silicon photonics device that includes an integrated circuit structure having optical transducers thereon and has a first surface, a block surface of a fastening block is bonded to the first surface, the fastening block having a cantilevered arm having a cantilever surface parallel to the block surface. At 802, the cantilever surface is configured for bonding to the fitting of the optical fiber cable at a cantilever area at least as large as the bonding area. At 803, the cantilever surface is spaced away from the block surface by a step distance to accommodate alignment of the fitting of the optical cable to the optical transducers. Method 800 then ends.

Thus it is seen that a structure and method for bonding an optical fiber cable to a silicon photonics device, with less susceptibility to detachment caused by bending or transverse forces, have been provided.

As used herein and in the claims which follow, the construction “one of A and B” shall mean “A or B.”

It is noted that the foregoing is only illustrative of the principles of the invention, and that the invention can be practiced by other than the described embodiments, which are presented for purposes of illustration and not of limitation, and the present invention is limited only by the claims which follow.

What is claimed is:

1. A silicon photonics communications device configured for fastening thereto a fitting of an optical fiber cable, the silicon photonics communications device comprising:
an integrated circuit structure having optical transducers thereon and having a first surface; and
a fastening block having a bonding area of a block surface bonded to the first surface and having a cantilevered arm having a cantilever surface parallel to the first surface, wherein:
the cantilever surface is configured for bonding to the fitting of the optical fiber cable at a cantilever area at least as large as the bonding area, and
the cantilever surface is spaced away from the block surface by a step distance to accommodate alignment of the fitting of the optical cable to the optical transducers.

2. The silicon photonics communications device of claim 1 wherein:
the optical transducers are on a second surface perpendicular to the first surface; and
the cantilevered arm extends beyond the second surface, and is configured for bonding to the fitting of the optical fiber cable to hold an end face of the fitting of the optical fiber cable, at which ends of optical fibers are exposed, adjacent to the optical transducers on the second surface.

3. The silicon photonics communications device of claim 2 wherein the cantilever surface is configured for bonding to the fitting of the optical fiber cable at a cantilever area at least 150% as large as the bonding area.

4. The silicon photonics communications device of claim 2 wherein the step distance is selected, taking into account thickness of a bonding layer, so that the exposed ends of the optical fibers are aligned with the optical transducers.

5. The silicon photonics communications device of claim 1 wherein the block surface is separated from the cantilever surface by a right-angle step.

6. The silicon photonics communications device of claim 1 wherein the block surface is separated from the cantilever surface by a chamfered edge.

7. The silicon photonics communications device of claim 1 wherein the fastening block has a first coefficient of thermal expansion that is matched to a second coefficient of thermal expansion of the integrated circuit structure.

8. The silicon photonics communications device of claim 7 wherein:
the integrated circuit structure comprises a silicon die; and
the fastening block comprises glass.

9. A method of fastening a fitting of an optical fiber cable to a silicon photonics communications device, the silicon photonics communications device including an integrated circuit structure having optical transducers thereon and having a first surface, the method comprising:
bonding to the first surface a block surface of a fastening block, the fastening block having a cantilevered arm having a cantilever surface parallel to the block surface;
configuring the cantilever surface for bonding to the fitting of the optical fiber cable at a cantilever area at least as large as the bonding area; and
spacing the cantilever surface away from the block surface by a step distance to accommodate alignment of the fitting of the optical cable to the optical transducers.

10. The method of fastening a fitting of an optical fiber cable to a silicon photonics communications device according to claim 9, where the optical transducers are on a second surface perpendicular to the first surface, the method comprising:
extending the cantilevered arm beyond the second surface; and
configuring the cantilevered arm for bonding to the fitting of the optical fiber cable to hold an end face of the fitting of the optical fiber cable, at which ends of optical fibers are exposed, adjacent to the optical transducers on second surface.

11. The method of fastening a fitting of an optical fiber cable to a silicon photonics communications device according to claim 10, wherein:
configuring the cantilever arm for bonding to the fitting of the optical fiber cable to hold an end face of the fitting of the optical fiber cable, at which ends of optical fibers are exposed, adjacent to the optical transducers on second surface, comprises configuring the cantilever arm for bonding to the fitting of the optical fiber cable at a cantilever area at least 150% as large as the bonding area.

12. The method of fastening a fitting of an optical fiber cable to a silicon photonics communications device according to claim 10, comprising selecting the step distance, taking into account thickness of a bonding layer, so that the exposed ends of the optical fibers are aligned with the optical transducers.

13. The method of fastening a fitting of an optical fiber cable to a silicon photonics communications device according to claim 9, comprising separating the block surface from the cantilever surface by a right-angle step.

14. The method of fastening a fitting of an optical fiber cable to a silicon photonics communications device according to claim 9, comprising separating the block surface from the cantilever surface by a chamfered edge.

15. The method of fastening a fitting of an optical fiber cable to a silicon photonics communications device according to claim 9, comprising matching a first coefficient of thermal expansion of the fastening block to a second coefficient of thermal expansion of the integrated circuit structure.

16. A photonic communications assembly comprising:
an optical fiber cable having a cable fitting;
a silicon photonics integrated circuit communications structure having optical transducers thereon and having a first surface; and
a fastening block having a bonding area of a block surface bonded to the first surface and having a cantilevered arm having a cantilever surface parallel to the first surface, wherein:
the cantilever surface is bonded to the fitting of the optical fiber cable at a cantilever area at least as large as the bonding area, and
the cantilever surface is spaced away from the block surface by a step distance to accommodate alignment of the fitting of the optical cable to the optical transducers.

17. The photonic communications assembly of claim 16 wherein:
the optical transducers are on a second surface perpendicular to the first surface; and
the cantilevered arm extends beyond the second surface, and is configured for bonding to the fitting of the optical fiber cable to hold an end face of the fitting of the optical fiber cable, in which ends of optical fibers are exposed, adjacent to the second surface.

18. The photonic communications assembly of claim 17 wherein the cantilever surface is configured for bonding to the fitting of the optical fiber cable at a cantilever area at least 150% as large as the bonding area.

19. The photonic communications assembly of claim 17 wherein the step distance is selected, taking into account thickness of a bonding layer, so that the exposed ends of the optical fibers are aligned with the optical transducers.

20. The photonic communications assembly of claim 16 wherein the block surface is separated from the cantilever surface by a right-angle step.

21. The photonic communications assembly of claim 16 wherein the block surface is separated from the cantilever surface by a chamfered edge.

22. The photonic communications assembly of claim 16 wherein the fastening block has a first coefficient of thermal expansion that is matched to a second coefficient of thermal expansion of the integrated circuit structure.

23. The photonic communications assembly of claim 22 wherein:
the integrated circuit structure comprises a silicon die; and
the fastening block comprises glass.
